(19) United States
(12) Patent Application Publication
(10) Pub. No.: US 2013/0238668 A1
(43) Pub. Date: Sep. 12, 2013

(54) IMPLEMENTING A SCALABLE TEST ENVIRONMENT

(71) Applicants: Kalambur Subramaniam, Bangalore (IN); Rajesh Kumar Mishra, Bangalore (IN); Mandar Nanivadekar, Bangalore (IN); Prakash B. Angadi, Whitefield (IN); Albrecht Schroth, Herrenberg (DE)

(72) Inventors: Kalambur Subramaniam, Bangalore (IN); Rajesh Kumar Mishra, Bangalore (IN); Mandar Nanivadekar, Bangalore (IN); Prakash B. Angadi, Whitefield (IN); Albrecht Schroth, Herrenberg (DE)

(21) Appl. No.: 13/414,175

(22) Filed: Mar. 7, 2012

(51) Int. Cl. G06F 7/00

(52) U.S. Cl. 707/803; 707/E17.01; 707/E17.044

(57) ABSTRACT

An embodiment provides a system and method for implementing a scalable test environment. The method includes modeling, within a file system environment creator executing on a computing device, a structure of a file system used by an application and intercepting a system call from the application to the file system at the file system environment creator. The method also includes generating a content of the file system dynamically within the file system environment creator based on the system call and the structure of the file system.

### BACKGROUND

In a test environment, the performance of an application as it accesses a file system may be evaluated. For example, software applications such as Information Management (IM) products may be used for a wide range of services that backup and archive large amounts of customer data, such as data protection, archiving, and records management. Because the amount of data accessed by the IM products is large, the scalability of the IM products is tested.

The customer data may be protected, stored in a suitable location, and restored using the IM products. Each customer data set introduces a unique file system schematic to the IM product, as each data set is different. For example, one file system may have a large number of small files in a single directory or at a mount point, while another file system has a small number of large files that collectively contains a large amount of data. Additionally, the file systems may include extensive nesting levels for the directories and files.

For testing purposes, the file systems are recreated as they exist at customer sites. The time spent creating different combinations of the file system content and structure may range from a few days to several weeks. In many cases, a large amount of storage space is used for maintaining such varied file systems for testing, resulting in high power costs. Additionally, verification of data that has been manipulated in a testing scenario may involve the time consuming process of generating checksums for the entire data set. Limited hardware resources can also cause scheduling delays when the hardware storage space is not available to replicate a file system for testing purposes.

### BRIEF DESCRIPTION OF THE DRAWINGS

Certain embodiments are described in the following detailed description and in reference to the drawings, in which:

FIG. 1 is a block diagram of a computing system in which a scalable test environment for applications may be implemented, in accordance with embodiments;

FIG. 2 is a schematic of a file system modeled by the file system environment creator, in accordance with embodiments;

FIG. 3 is a block diagram of a scalable test environment that may be used to dynamically model the content of applications, in accordance with embodiments;

FIG. 4 is a process flow diagram showing a method for implementing a scalable test environment for applications, in accordance with embodiments;

FIG. 5 is a process flow diagram showing another method for implementing a scalable test environment for applications, in accordance with embodiments; and

FIG. 6 is a block diagram showing a tangible, non-transitory computer-readable medium that stores a protocol adapted to implement a scalable test environment for applications, in accordance with embodiments.

### DETAILED DESCRIPTION OF SPECIFIC EMBODIMENTS

As discussed above, Information Management (IM) products may be used for a wide range of applications, such as data protection, archiving, and records management. Typical operations carried out by IM products include enumerating files on a file system, reading file data and attributes, and sending the file system data to a data store. Subsequent operations on the file system may lead to changes in file attributes, which are file contents that are tracked by these applications. As described herein, an application is a set of instructions implemented by a computer. Further, as used herein, a file system is an organized collection of data that may be stored in memory or generated in response to applications attempting to access file system data.

Embodiments described herein provide for the implementation of a scalable test environment without extensive use of dedicated storage devices. In various examples, the scalable test environment may be used to test the performance of software applications, such as IM products. For example, the scalable test environment may be used to determine whether a particular IM product is capable of dealing with a very large, complex set of data prior to the release of the IM product into the market.

In various examples, a file system environment creator may be used to generate the content of a file system within the scalable test environment. The content of the file system may be generated in response to a system call from a particular application, such as an IM application. The file system environment creator may intercept the system call from the application to the file system, and may generate a model of the content of the file system based on the system call and the structure of the file system. In other words, the file system environment creator may allow the testing of a software application, such as an IM product, without the use of a dedicated storage space for the file system used to test the capabilities of the IM product.

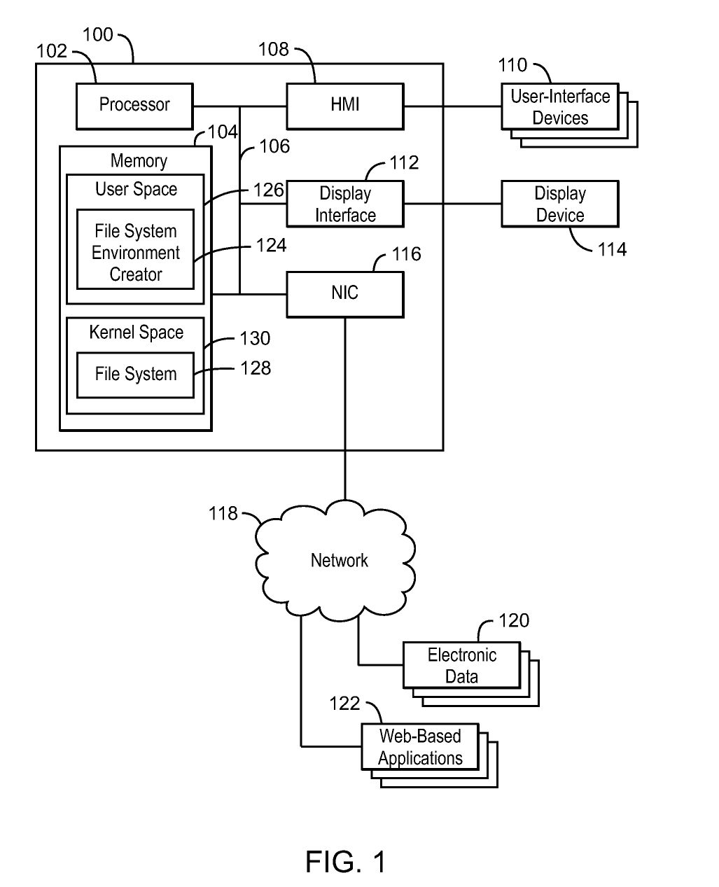

FIG. 1 is a block diagram of a computing system 100 in which a scalable test environment for applications may be implemented, in accordance with embodiments. In various examples, the computing system 100 may be a desktop computer, laptop computer, mobile computing device, or server, among others. The computing system 100 includes a processor 102 that is adapted to execute stored instructions, as well as a memory device 104 that stores instructions that are executable by the processor 102. The processor 102 can be a single core processor, a multi-core processor, a computing cluster, or any number of other configurations. The processor 102 is connected through a bus 106 to one or more input and output devices.

A human machine interface 108 may be adapted to connect the computing system 100 through the bus 106 to user-interface devices 110. The user-interface devices 110 may include, for example, a keyboard and a pointing device, such as a mouse, trackball, touchpad, joy stick, pointing stick, stylus, or touch screen, among others. The computing system 100 may also be linked through the bus 106 to a display interface 112 adapted to connect the computing system 100 to a display device 114, wherein the display device 114 may include a computer monitor, camera, television, projector, or mobile device, among others.

A network interface controller (NIC) 116 may be adapted to connect the computing system 100 through the bus 106 to a network 118. Through the network 118, electronic data 120 may be downloaded and stored within the memory device 104. Further, through the network 118, web-based applications 122 may be downloaded and stored within the memory device 104, or may be accessed through a Web browser. In examples, an IM product may be a web-based application 122 or can be stored within the memory device 104.

The memory device 104 can include random access memory (RAM), read only memory (ROM), flash memory, or any other suitable memory systems. The memory device 104 can also include, or be communicably coupled to, a storage device (not shown). The storage device may include a hard drive, an optical drive, a thumb drive, an array of drives, or any combinations thereof. The memory device 104 may be adapted to store instructions that are executable by the processor 102. These instructions implement a method that may include modeling a structure of a file system, intercepting a system call from an application to the file system, and generating the content of the file system based on the structure of the file system and the system call.

The memory device 104 can also include components for implementing these instructions, including a file system environment creator 124 located within a user space 126 and a file system 128 located within a kernel space 130. The user space 126 and the kernel space 130 may be memory components within the memory device 104 that are in operative communication with one another. The file system 128 maintains and organizes the structure and content of files within the memory device 104 of the computing system 100. In various examples, the file system 128 is backed up using an IM application. “Backing up” the file system includes copying the data contained within the file system to another location. Further, in examples, the file system environment creator 124 may dynamically model the state of the file system 128, as specified by system calls from applications, without the use of a dedicated storage space within the computing system 100. The state of the file system is the corresponding structure and content of the file system. By modeling the state of the file system 128, the file system environment creator 124 can respond to various system calls to the file system 128.

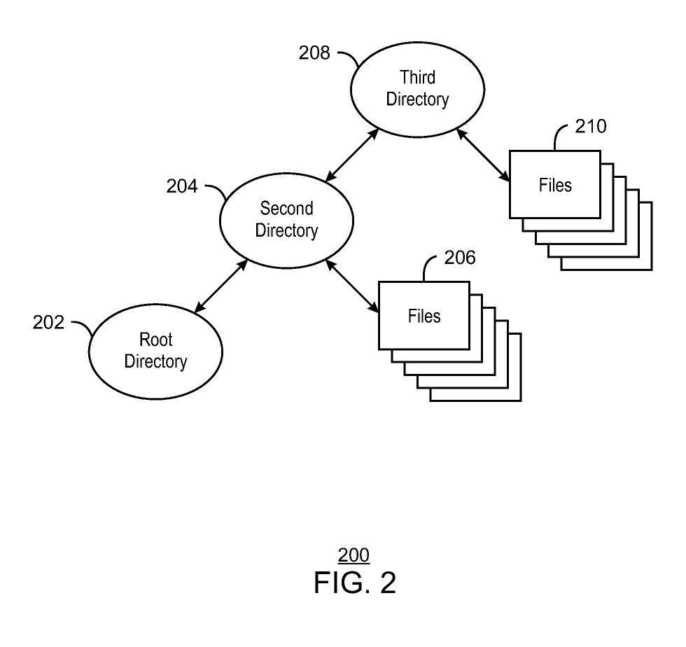

FIG. 2 is a schematic of a file system 200 modeled by the file system environment creator 124, in accordance with embodiments. The file system environment creator may execute on a computing device. The file system 200 may be modeled to provide the same organized data as a file system stored in memory, such as file system 128. Like numbered items are as described with respect to FIG. 1. The file system 200 can model a disk file system, a flash file system, a tape file system, a database file system, a transactional file system, or a network file system, among others. However, the file system 200 is generated in response to a particular application issuing system calls that are intercepted by the file system environment creator 124. In response to an intercepted call, the file system environment creator 124 may send data to the application that issued the system call. In this manner, the file system environment creator 124 creates a file system environment for a particular application, without allocating dedicated storage space to the file system. In some examples, the file system environment creator 124 may store specific data. The specific data is one or more templates, such as policy files, word processing software templates, or spreadsheet software templates. In other examples, the specific data is stored on the root file system from which the file system environment creator 124 operates. The file system environment creator 124 may keep track of memory or storage areas that are being used by particular files, as well as those that are not being used, as viewed by the particular application whose system calls have been intercepted by the file system environment creator 124. For example, if the particular application has sent a system call to perform operations associated with file X, the file system environment creator 124 can create data corresponding to file X and keep track of the particular application's usage of file X.

The file system 200 may include a root directory 202. The root directory 202 is the top-most directory within the file system 200, and may be the starting point from which all other directories within the file system 128 originate. A second directory 204 is located within the root directory 202. The second directory 204 contains files 206. In examples, the second directory 204 contains a small number of files 206, on the order of a few hundred files. In other examples, the second directory 204 contains a large number of files 206, on the order of a billion files.

A third directory 208 is also located within the root directory 202. In some examples, the third directory 208 is a sub-directory located within the second directory 204, as shown in FIG. 2. In other examples, the third directory 208 is located immediately within the root directory 202, such that the third directory is on the same level as the second directory 204. The third directory 208 contains files 210. The file system 200 may further include any number of additional directories, sub-directories, or files, according to the specific application issuing calls to the file system. The state of the file system 200 may be defined by the structure of the file system 200, which includes the organization of the directories 202, 204, and 208. The state of the file system 200 may also be defined by the content of the file system 200, which includes the data contained within the files 206 and 210.

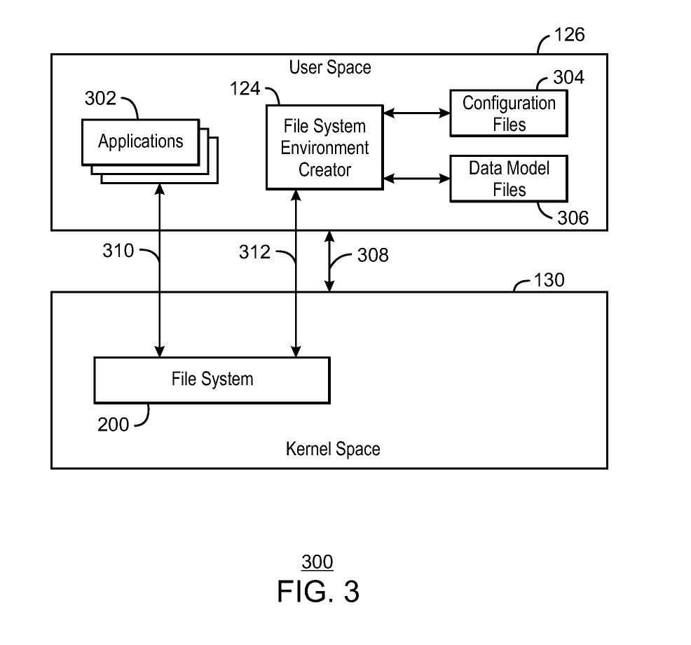

FIG. 3 is a block diagram of a scalable test environment 300 that may be used to dynamically model the content of applications, in accordance with embodiments. Like numbered items are as described with respect to FIGS. 1 and 2. In various examples, the scalable test environment 300 may be implemented within the computing system 100. The scalable test environment 300 may be used to model the content of an application 302 using the file system environment creator 124. The application 302 may include, for example, an information management (IM) product stored in the memory device 104 or accessible through the network 118. The IM product may be used for data protection, archiving, or records management, among others. In some examples, a generator other than the file system environment creator 124 may be used to model the actual data of the application 302.

The application 302, a configuration file 304, and a data model file 306 may be located within separate mount points in the user space 126, and may be in operative communication with the file system environment creator 124. A mount point may be a root location of the file system. In examples, the configuration file 304 and the data model file 306 may be extensible markup language (XML) files that can be created or edited by any suitable text editor. The configuration file 304 and the data model file 306 may be used by the file system environment creator 124 to model the structure of the file system 200. The structure of the file system 200 may include a number of directories within the file system, a number of files in each directory of the file system, or a depth of the file system. In examples, the structure of the file system 200 may be determined from a hardware configuration of the computing system 100.

In examples, the data model file 306 may be read by the file system environment creator 124 in order to determine the various types of data objects that constitute the application 302, such as, for example, directories, files, and symbolic links, as well as their attributes. The configuration file 304 may provide parameters relating to the manner in which the application 302 organizes data, such as, for example, the number of directories, the number of files per directory, or the depth of the file system, among others. The data model file 306 may also specify a nomenclature mechanism that is used to name data objects within the data model file 306. These data object names may be used by the application 302 to refer to various data objects within the instance of the application 302. In some examples, a system call from the application 302 may refer to specific data object names. The file system environment creator 124 may then be used to parse the corresponding data objects in order to determine the attributes of such data objects.

The file system 200 may be located within the kernel space 130 of the computing system 100, which is in operative communication with the user space 126, as indicated by arrow 308. In examples, when the application 302 sends a system call to the file system 200, as indicated by arrow 310, the file system environment creator 124 intercepts the system call, as indicated by arrow 312. The file system environment creator 124 may then generate the content of the file system 200 within the user space 126. In this manner, the content of the file system 200 may be dynamically generated on the fly by the file system environment creator 124 in response to the system call from the application 302. As a result, the content of the file system 200 is not stored in the user space 126 or the kernel space 130.

The system call from the application 302 may include, for example, a read operation or a write operation, among others. The system call may be used to delete, rename, or recreate certain files at a particular point in time, change file attributes, or change a few blocks of certain files at a particular point in time. The system call from the application 302 may also be used to backup or restore data, or to verify backed-up or restored data.

In a scenario where the application 302 is used to backup or restore data, the application may be tested as follows. The file system environment creator 124 may access configuration files 304 and data model files 306 in order to model the structure of the file system 200 used by the application 302. When the application 302 issues a system call to backup or restore data, the file system environment creator 124 may intercept the system call. The file system environment creator 124 may then generate the content of the file system 200 based on the system call, as well as the configuration and data model files. Thus, the application 302 will access content generated dynamically by the file system environment creator 124. In examples, the file system environment creator 124 may verify the content generated in response to the system call by referring to the configuration files 304 and the data model files 306. For example, in the case of a restore operation, the file system environment creator 124 may ensure that the content written by the application 302 is the same as the content that was generated dynamically by the file system environment creator 124.

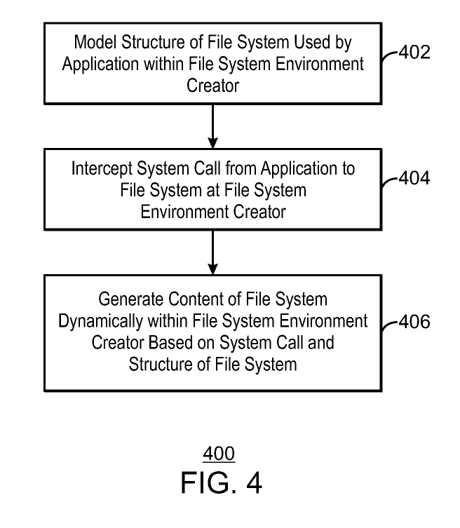

FIG. 4 is a process flow diagram showing a method 400 for implementing a scalable test environment for applications, in accordance with embodiments. The method 400 may be used to generate the content of a file system without the use of a dedicated storage location or storage device. The method 400 may be implemented within a computing environment, such as the computing system 100 described with respect to FIG. 1. Further, the method 400 may be used to test the performance of a particular application, wherein the application may be an IM product. The application may be directly accessible through a storage device within the computing environment, or may be accessible through the network.

The method begins at block 402 with the modeling of the structure of the file system used by the application within the file system environment creator. This may be accomplished through the use of a configuration file, such as an XML configuration file, and a data model file, such as an XML data model file. The configuration file is a file that contains policies applicable to a file system at a particular instance in time, and may contain information regarding how the application organizes data within the file system such as the number of directories, how many files per directory, and the depth of the file system. Thus, the policies define how a file system or database is structured. In various examples, modeling the structure of the file system includes determining the number of directories within the file system, the number of files within the file system, the number of files in each directory of the file system, or the depth of the file system, or any combinations thereof. In some examples, the structure of the file system may also be determined by a hardware configuration of the computing environment.

The data model file is a file that contains policies regarding the types of objects accessed by the application. The data model file can specify a nomenclature mechanism that is used to name objects accessed by the application. Further, the policies in the data model file may apply to the content of the file system, such as restrictions on the values of the generated content.

At block 404, a system call from the application to the file system may be intercepted at the file system environment creator. By intercepting the system call, the file system environment creator may identify the object associated with the system call by name according to the data model file. Data associated with the object may be generated as specified in the configuration file. In examples, the requested data associated with the object is returned to the application without the use of a dedicated storage space for the generated data. This may allow for the performance of tests and the generation of the content and the structure of the file system dynamically. As discussed above, the system call from the application may relate to read operations, write operations, backup operations, or restoration operations, among others. Further, the system call from the application may be used to perform any of a number of information management procedures within the computing environment.

In various examples, the application may attempt to traverse the file system directly by reading the contents of the root mount point, and opening and reading the contents of each directory through “open directory” or “read directory” system calls. However, the file system environment creator may intercept the system calls through a hooking procedure. For example, when a directory is open for reading a list of files or sub-directories, hooks attached to the Open Directory or Read Directory system calls cause them to be sent to the file system environment creator, allowing the application to operate within the scalable test environment.

At block 406, the content of the file system may be generated within the file system environment creator based on the system call and the structure of the file system. This may be accomplished by determining, for each file within the file system, a size of the file, a file permission associated with the file, and data within the file. In this manner, an arbitrary sized file system is generated. In various examples, the content of the file system that is generated may include modified content of the file system, as specified by the system call from the application. For example, when the intercepted system call includes instructions to write data to a file X, then return the entire content of file X, the content generated by the file system environment creator includes the entire content of file X, as particularly modified by the data written to file X. Such modified content is dynamically generated within the file system environment creator without resulting in the modification of the content of the file system itself. In other words, the content of the file system may be generated on the fly without using data from a dedicated storage location or device. In another example, the data or metadata associated with specific content within the file system, such as the size of a file, the content of the data in the file, or the permissions on the file, may be generated by the file system environment creator. This may allow for the testing of multiple configurations without investment in hardware. Further, the amount of power consumed for the testing process may be significantly reduced.

In various examples, after the Open Directory or Read Directory system calls are sent to the file system environment creator at block 404, the file system environment creator may analyze applicable policies located within the configuration file, such as, for example, an XML configuration file. The file system environment creator may then generate the names of the files and directories dynamically.

FIG. 4 is not intended to indicate that the steps of method 400 are to be executed in any particular order. In addition, any number of the steps of method 400 may be deleted, or any number of additional steps may be included, depending on the specific application. In various examples, after the content of the file system is dynamically generated within the file system environment creator, the content may be returned to the application. A user of the application may then determine whether the application is functioning correctly. For example, after the file system generates the names of the files and directories dynamically at block 406, the file system environment creator may return the generated names of the file and directories to the application that initiated the system call. The file system environment creator may return the generated names of the files and directories to the application by filling up the buffer with a content string specified by the applicable policies found within the XML configuration file. In some cases, this may be useful for determining whether a particular application is capable of dealing with large, varied data sets.

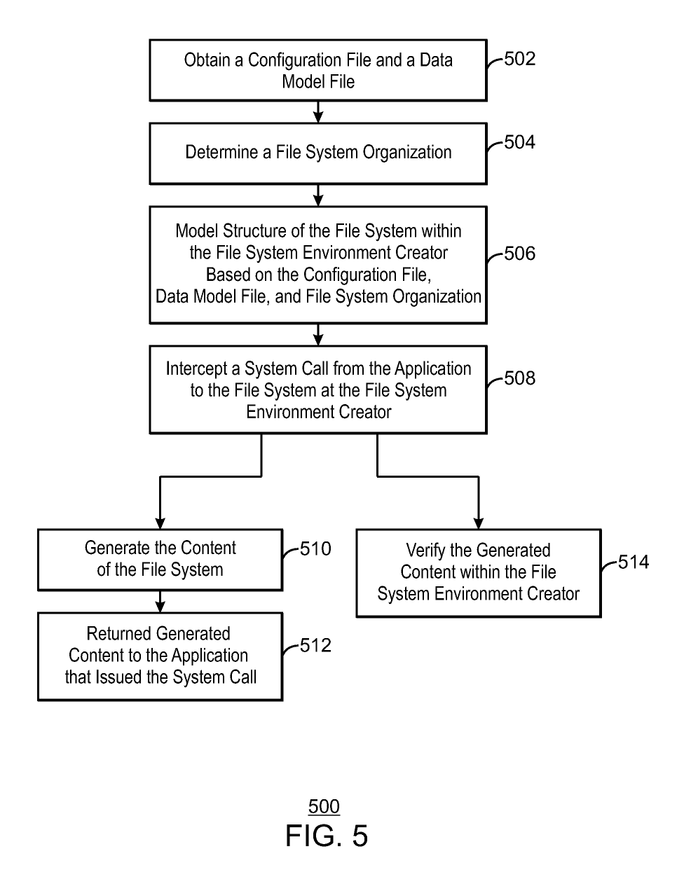

FIG. 5 is a process flow diagram showing another method 500 for implementing a scalable test environment for applications, in accordance with embodiments. In examples, the scalable test environment is used to test a performance of the application, such as an information management (IM) product. At block 502, a configuration file and a data model file may be obtained. At block 504, a file system organization may be determined, such as a number of directories within the file system, a number of files within the file system, a number of files in each directory of the file system, or the depth of the file system, or any combinations thereof. At block 506, the structure of the file system used by the application is modeled within the file system environment creator. The structure may be based on the configuration file, the data model file, and the organization of the file system, such as the number of files within the file system, the number of files in each directory of the file system, and the depth of the file system.

At block 508, a system call from the application to the file system may be intercepted at the file system environment creator. If the system call is a read or write operation, process flow continues to block 510. If the system call is one that occurs during a restore operation, process flow continues to block 514. At block 510, the content of the file system is generated by determining, for each file within the file system, a size of the file, a file permission associated with the file, and data within the file. The content of the file system may include modified content of the file system as specified by the system call. In examples, the file system is a database, and the content of the database is determined by policies within the configuration file.

At block 512, the generated content of the file system is returned to the application that issued the system call. At block 514, the generated content may be verified in response to the system call within the file system environment creator. In examples, the file system environment creator can work in a “verify” mode where metadata and data written to the generated file system can be interpreted by the file system environment creator generator and verified against a policy within the data model file. Such a verification occurs when an application is performing a restore operation using the file system environment creator.

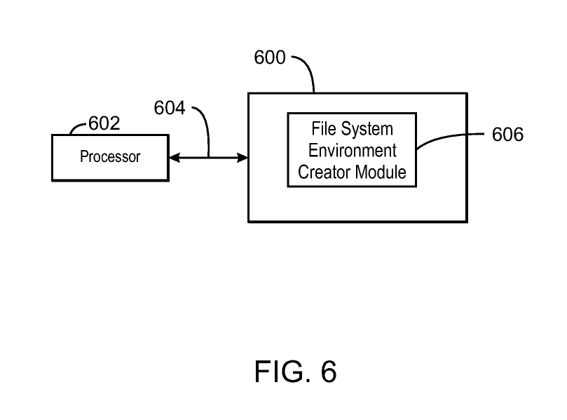

FIG. 6 is a block diagram showing a tangible, non-transitory computer-readable medium 600 that stores a protocol adapted to implement a scalable test environment for applications, in accordance with embodiments. The computer-readable medium 600 may be accessed by a processor 602 over a computer bus 604. Furthermore, the computer-readable medium 600 may include code to direct the processor 602 to perform the steps of the current method.

The various software components discussed herein may be stored on the tangible, non-transitory computer-readable medium, as indicated in FIG. 6. For example, a file system environment creator module 606 may be configured to model the structure of a file system, intercept a system call from an application to the file system, and generate the content of the file system based on the system call and the structure of the file system. The file system environment creator module 606 may also be configured to generate the content of the file system dynamically without the use of any dedicated storage devices. Further, the tangible, non-transitory computer-readable medium may include any number of additional software components not shown in FIG. 6.

While the present techniques may be susceptible to various modifications and alternative forms, the exemplary embodiments discussed above have been shown only by way of example. It is to be understood that the technique is not intended to be limited to the particular embodiments disclosed herein. Indeed, the present techniques include all alternatives, modifications, and equivalents falling within the true spirit and scope of the appended claims.

1. A computer-implemented method for implementing a scalable test environment, comprising:
modeling, within a file system environment creator executing on a computing device, a structure of a file system used by an application;
intercepting a system call from the application to the file system at the file system environment creator; and
generating a content of the file system dynamically within the file system environment creator based on the system call and the structure of the file system.

2. The computer-implemented method of claim 1, wherein the scalable test environment is used to test a performance of the application, and wherein the application is an information management product.

3. The computer-implemented method of claim 1, wherein modeling the structure of the file system comprises obtaining a configuration file and a data model file.

4. The computer-implemented method of claim 3, wherein generating a content of the file system comprises generating a content of a database, wherein the content of the database is determined by policies within the configuration file.

5. The computer-implemented method of claim 1, wherein modeling the structure of the file system comprises determining at least one of a number of directories within the file system, a number of files within the file system, a number of files in each directory of the file system, and the depth of the file system, and any combinations thereof.

6. The computer-implemented method of claim 1, wherein generating the content of the file system comprises determining, for each file within the file system, at least one of a size of the file, a file permission associated with the file, and data within the file.

7. The computer-implemented method of claim 1, wherein generating the content of the file system dynamically comprises returning data requested by the system call back to the application in memory without a use of a dedicated storage space.

8. The computer-implemented method of claim 1, further comprising verifying the content generated in response to the system call within the file system environment creator.

9. A system for implementing a scalable test environment, comprising:
a processor that is adapted to execute stored instructions; and
a storage device that stores instructions, the storage device comprising processor executable code that, when executed by the processor, is configured to:
model, within a file system environment creator, a structure of a file system used by an application;
intercept a system call from the application to the file system at the file system environment creator; and
generate a content of the file system dynamically within the file system environment creator based on the system call and the structure of the file system.

10. The system of claim 9, wherein the application comprises an information management product stored in the storage device and a storage location accessible through a network.

11. The system of claim 9, wherein the structure of the file system is determined by a configuration file and a data model file stored in at least one of the storage device and a storage location accessible through a network, and a change to the configuration file comprises a change to the structure of the file system.

12. The system of claim 9, wherein the content comprises a modified content of the file system as specified by the system call from the application, and wherein the modified content of the file system is not stored within the file system.

13. The system of claim 9, wherein the structure of the file system is determined by a hardware configuration of the system.

14. The system of claim 9, wherein the file system is located within a kernel space of the system, and the file system environment creator, a configuration file, and a data model file are located within a user space of the system.

15. The system of claim 9, wherein the storage device stores instructions that, when executed, cause the processor to generate the content of the file system without a dedicated storage location in response to the system call.

16. A tangible, non-transitory, computer-readable medium comprising code to direct a processor to:
model, within a file system environment creator, a structure of a file system used by an application;
intercept a system call from the application to the file system at the file system environment creator; and
generate a content of the file system dynamically within the file system environment creator based on the system call and the structure of the file system.

17. The tangible, non-transitory, computer-readable medium of claim 16, wherein modeling the structure of the file system comprises obtaining a configuration file and a data model file.

18. The tangible, non-transitory, computer-readable medium of claim 16, wherein modeling the structure of the file system comprises determining at least one of a number of directories within the file system, a number of files in each directory of the file system, and a depth of the file system.

19. The tangible, non-transitory, computer-readable medium of claim 16, wherein the file system environment creator is used to generate the content of the file system dynamically without using data from a storage device.

20. The tangible, non-transitory, computer-readable medium of claim 16, wherein the application comprises an information management product.
